(19) United States
(12) Patent Application Publication
(10) Pub. No.: US 2009/0102147 A1
(43) Pub. Date: Apr. 23, 2009

(54) Small space rough terrain mobility transport

(76) Inventors: Craig L. Moorhead, Los Gatos, CA (US); Duane R. Serrano, San Jose, CA (US)

Correspondence Address: Craig L. Moorhead, 341 Los Gatos Blvd, Los Gatos, CA, 95032, US

(21) Appl. No.: 11/977,058

(22) Filed: Oct. 23, 2007

(51) Int. Cl. B25H 5/00

(52) U.S. Cl. 280/32.6

(57) ABSTRACT

A small space rough terrain mobility transport for assisting a person in moving through a small low clearance space with rough terrain such as the crawl space beneath a building. The inventive device includes a deck assembly 10, a plurality of axle studs 40, a plurality of wheel assemblies 20 and padding 30. The deck assembly 10 includes turned up edges at each side to create a wheel guard 12 that protects the operator from contact with the wheels 20 and provides the means to control the direction of travel. The wheels 20 are of a size to fit into a low clearance area while maintaining low resistance while rolling across rough and soft surfaces such as soils. The wheel tread 24 are conducive for providing traction across rough terrain and soft soils. The wheel construction is sufficiently flexible to provide shock absorption. A material that is placed on top of the deck surface 11 and is water and tear resistant while being sufficiently soft to provide shock absorbing characteristics while shaped in a profile for the comfort of the operator. The axle stud 40 has an attachment end 42 and an axle end 41. The shape of the axle stud 40 is cylindrical and is preferably larger in diameter at the attachment end 42 than the axle end 41 and creates a shoulder 43 to support one of the two sides of the wheel assembly 20. Further the length of the widened attachment end 42 is a length sufficient to provide adequate clearance between the wheel assembly 20 and the wheel guard 12 that it is attached to. The axle stud 40 is smaller in diameter at the axle end 41 and is continuously straight for a length to be equal to the width of the wheel assembly hub 23 plus the thickness of the attachment washers 21 and threaded nut 22 necessary to secure the wheel assembly 20 to the axle stud 40. Threads are cut into the end most area 41 of the axle stud 40 for a length sufficient to receive the corresponding washers 21 and threaded nut 22 that secures the wheel assembly 20.

### BACKGROUND OF THE INVENTION

1. Field of the Invention

The present invention relates generally to crawler transports and more specifically it relates to a small space rough terrain mobility transport for assisting a person in moving through a small low clearance space with rough terrain such as the crawl space beneath a building.

2. Description of the Related Art

It can be appreciated that crawler transports have been in use for years. Typically, crawler transports are comprised of mechanic's creepers that provides an elongated platform with castors attached to the underside to allow for a person's mobility into a low clearance space while traversing a smooth surface such as beneath an automobile. Another existing product is a creeper type of device utilizing a track drive with attached spring retractable rails for the purpose of providing mobility for a person while lying on their back in accessing low clearance and rough terrain locations such as under a house. Another existing product is a contoured type creeper device made of a smooth shell and removable wheels that function to roll across a smooth surface or slide across a rough terrain by removing the wheels.

Conventional mechanics' creepers have a rectangular platform equipped with a head rest, the platform being supported at minimal ground clearance on three or four casters, or a combination of wheels and casters. While the conventional creepers are suited for conditions found in many workshops and on concrete driveways, they are impractical on uneven and soft surfaces commonly found in a crawlspace under a building and under mobile homes, for example. Particularly, the size of the platform is insufficient for traversing over, under and around obstructions such as rocks, foundation walls, plumbing pipes, and heating ducts commonly found thereon. Also, the wheels of prior art creepers are ineffective for support on soft and uneven terrain including loose soil and rocks. Instead of providing rolling support, the wheels dig in while failing to roll, the platform sinking to the ground as well, and the user must find other means of access.

Another problem with conventional crawler transports are that they presume that the operating person will be lying on their back and using their legs and feet to facilitate movement which unnecessarily restricts the operating person's visibility while moving in a forward direction. Another problem with conventional crawler transports are the wheel types do not provide adequate functionality over rough terrain. Another problem with conventional crawler transporters are they depend on the operating person to be lying on the apparatus, on their back, placed directly on the rough terrain surface and pushing themselves with their legs to cause the apparatus to slide. The existing apparatus' relatively large sizes and shapes inhibit movement around, under and/or over encountered objects within the low clearance spaces such as in crawl spaces beneath buildings and other structures.

U.S. Pat. No. 5,397,139 (1995) to Simpson discloses a creeper having a contoured body platform with rotatably mounted wheels attached to the underside of the platform. The creeper of Simpson has significant disadvantages in that movement requires a user to be lying on their back making visibility in the direction of travel difficult. Propulsion of the user on the creeper would require the user to repeatedly bend their legs at the knees then straighten their legs. The main problem with this is movement would be difficult in low vertical clearance spaces. Further, the creeper of Simpson has a large physical size and a contoured shape that restricts maneuverability movement through a low clearance small space with obstructions and the contoured shape limits a user to only be lying on it on their back which results in restricted mobility of the device. Additionally, it's physical size and shape inhibits mounting and dismounting in constricted areas.

U.S. Pat. No. 4,185,846 (1980) to Black discloses a creeper having a parallel spaced pair of rigid tracks that are rollably mounted to the underside of a platform and are used by an operator for “walking” the creeper along a surface. The creeper of Black has significant disadvantages in that movement requires the user to be lying on their back making visibility in the direction of travel difficult, and the creeper has limited turning capability, if any, particularly on hard, flat surfaces. Also, traversing over objects other than moderately uneven terrain would not be possible. Further, when the tracks bridge across rocks, crests and the like, there is reduced clearance for the user or worker movement. Moreover, the long dimension of the creeper restricts maneuverability and significantly limits turning past or over obstacles.

Other creepers are disclosed in U.S. Pat. No. 1,649,721 (1927) to Mohler, U.S. Pat. No. 1,823,526 (1931) to Breeden, U.S. Pat. No. 4,875,694 (1989) to Hamrick, U.S. Pat. No. 4,909,524 (1990) to Paine, and U.S. Pat. No. 5,213,350 (1993) to Hermanson. These creepers are ineffective in that they need excessive ground clearance; they employ narrow wheels which have little float or traction in soft turf; they require padding for operator protection from sharp structural protrusions; they are useful only on hard or smooth surfaces; and/or they are not effective in hard or rocky soil.

While these devices may be suitable for the particular purpose to which they address, they are not suitable for assisting a person in moving through a small low clearance space with rough terrain such as the crawl space beneath a building. The main problem with conventional crawler transports are their physical size and/or contoured shapes impair movement through a small space and impairs movement of an operating person's arms and legs when used in a manner other than lying on their back which results in restricted mobility of the device. Additionally, their physical size and/or shape inhibits mounting and dismounting in constricted areas. Another problem is that they presume that the operating person will be lying on their back and using their legs and feet to facilitate movement which unnecessarily restricts the operating persons visibility while moving in a forward direction. Also, another problem is the wheel types do not provide adequate functionality over rough terrain. Another problem with conventional crawler transporters is that they depend on the operating person to be lying on their back on the apparatus placed directly on the rough terrain surface and pushing themselves with their legs to cause the apparatus to slide. The existing apparatus' relatively large sizes and shapes inhibit movement around, under and/or over encountered objects within the low clearance spaces such as in crawl spaces beneath buildings and other structures.

In these respects, the small space rough terrain mobility transport according to the present invention substantially departs from the conventional concepts and designs of the prior art, and in so doing provides an apparatus primarily developed for the purpose of assisting a person in moving through a small low clearance space with rough terrain such as the crawl space beneath a building.

### SUMMARY OF THE INVENTION

In view of the foregoing disadvantages inherent in the known types of crawler transports now present in the prior art, the present invention provides a new small space rough terrain mobility transport construction wherein the same can be utilized for assisting a person in moving through a small low clearance space with rough terrain such as the crawl space beneath a building.

The general purpose of the present invention, which will be described subsequently in greater detail, is to provide a new small space rough terrain mobility transport that has many of the advantages of the crawler transports mentioned heretofore and many novel features that result in a new small space rough terrain mobility transport which is not anticipated, rendered obvious, suggested, or even implied by any of the prior art crawler transports, either alone or in any combination thereof.

To attain this, the present invention generally comprises a deck assembly 10, a plurality of axle studs 40, a plurality of wheel assemblies 20 and padding 30. The deck assembly 10 includes turned up edges at each side to create a wheel guard 12 that protects the operator from contact with the wheels 20 and provides the means to control the direction of travel. The wheels 20 are of a size to fit into a low clearance area while maintaining low resistance while rolling across rough and soft surfaces such as soils. The wheel tread 24 is conducive for providing traction across rough terrain and soft soils. The wheel construction is sufficiently flexible to provide shock absorption. A material that is placed on top of the deck surface 11 and is water and tear resistant while being sufficiently soft to provide shock absorbing characteristics while shaped in a profile for the comfort of the operator. The axle stud 40 has an attachment end 42 and an axle end 41. The shape of the axle stud 40 is cylindrical and is preferably larger in diameter at the attachment end 42 than the axle end 41 and creates a shoulder 43 to support one of the two sides of the wheel assembly 20. Further the length of the widened attachment end 42 is a length sufficient to provide adequate clearance between the wheel assembly 20 and the wheel guard 12 that it is attached to. The axle stud 40 is smaller in diameter at the axle end 41 and is continuously straight for a length to be equal to the width of the wheel assembly hub 23 plus the thickness of the attachment washers 21 and threaded nut 22 necessary to secure the wheel assembly 20 to the axle stud 40. Threads are cut into the end most area 41 of the axle stud 40 for a length sufficient to receive the corresponding washers 21 and threaded nut 22 that secures the wheel assembly 20.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary objective of the present invention is to provide a small space rough terrain mobility transport that will overcome the shortcomings of the prior art devices.

Another objective of the present invention is to provide a small space rough terrain mobility transport for assisting a person in moving through a small low clearance space with rough terrain such as the crawl space beneath a building.

Another objective is to provide a small space rough terrain mobility transport that functions to improve mobility of an operating person through a low clearance environment with terrains ranging from and to include smooth to soft soils and uneven surfaces such as within a crawl space beneath a building and other structures.

Another objective is to provide a small space rough terrain mobility transport that provides assistance for operating persons with physical limitations.

Another objective is to provide a small space rough terrain mobility transport that prolong a persons capability to provide services accessing low clearance rough terrain environments.

Another objective is to provide a small space rough terrain mobility transport that reduce risk of injury of the operating person by lessening the physical stress required to perform work in low clearance, rough terrain environments with possible varied obstructions.

Another objective is to provide a small space rough terrain mobility transport that would decrease the amount of time necessary to perform tasks when it is required to move through low clearance rough terrain environments with possible varied obstructions.

Another objective is to provide a small space rough terrain mobility transport that reduces wear and tear on clothing and other protective equipment.

Another objective is to provide a small space rough terrain mobility transport that is light weight and compact in size so as to enter into and be removed from conventional under-floor access scuttle openings.

Other objectives and advantages of the present invention will become obvious to the reader and it is intended that these objects and advantages are within the scope of the present invention.

To the accomplishment of the above and related objectives, this invention may be embodied in the form illustrated in the accompanying drawings, attention being called to the fact, however, that the drawings are illustrative only and that changes may be made in the specific construction illustrated.

### BRIEF DESCRIPTION OF THE DRAWINGS

Various other objectives, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view of the present invention.

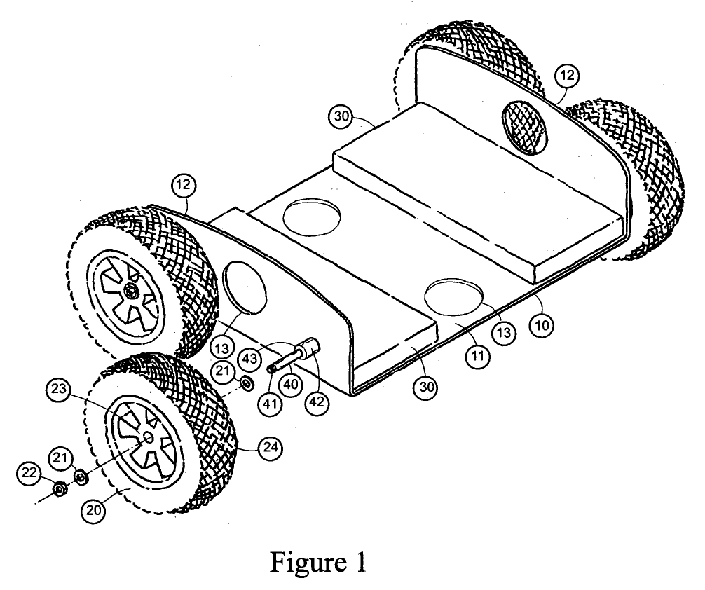

FIG. 2 is a combination front view and section view of the present invention.

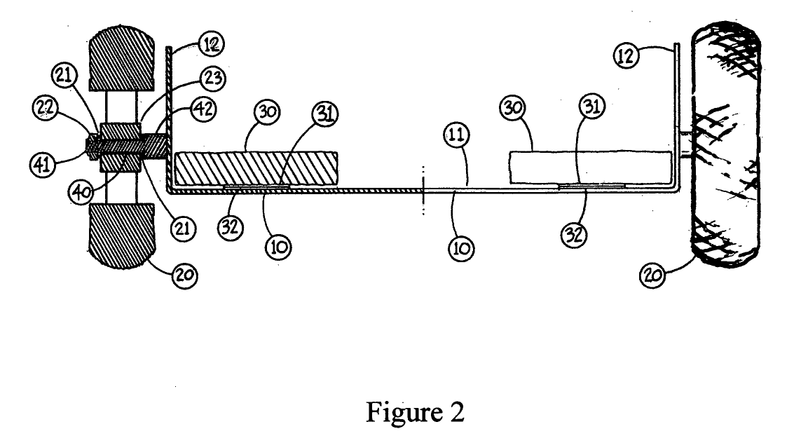

### DETAILED DESCRIPTION OF THE INVENTION

Turning now descriptively to the drawings, in which similar reference characters denote similar elements throughout the several views, the attached figures illustrate a small space rough terrain mobility transport which comprises a deck assembly 10, a plurality of axle studs 40, a plurality of wheel assemblies 20 and padding 30. The deck assembly 10 includes turned up edges at each side to create a wheel guard 12 that protects the operator from contact with the wheels 20 and provides the means to control the direction of travel. The wheels 20 are of a size to fit into a low clearance area while maintaining low resistance while rolling across rough and soft surfaces such as soils. The wheel tread 24 are conducive for providing traction across rough terrain and soft soils. The wheel construction is sufficiently flexible to provide shock absorption. A material that is placed on top of the deck surface 11 and is water and tear resistant while being sufficiently soft to be provide shock absorbing characteristics while shaped in a profile for the comfort of the operator. The axle stud 40 has an attachment end 42 and an axle end 41. The shape of the axle stud 40 is cylindrical and is preferably larger in diameter at the attachment end 42 than the axle end 41 and creates a shoulder 43 to support one of the two sides of the wheel assembly 20. Further the length of the widened attachment end 42 is a length sufficient to provide adequate clearance between the wheel assembly 20 and the wheel guard 12 that it is attached to. The axle stud 40 is smaller in diameter at the axle end 41 and is continuously straight for a length to be equal to the width of the wheel assembly hub 23 plus the thickness of the attachment washers 21 and threaded nut 22 necessary to secure the wheel assembly 20 to the axle stud 40. Threads are cut into the end most area 41 of the axle stud 40 for a length sufficient to receive the corresponding washers 21 and threaded nut 22 that secures the wheel assembly 20.

The deck assembly 10 includes turned up edges at each side to create a wheel guard 12 that protects the operator from contact with the wheels 20 and provides the means to control the direction of travel. The deck assembly 10 is composed of a flat aluminum plane having a forward to back direction, side to side direction and a top and bottom orientation. It is sufficient in stiffness to support an operating persons weight. The two side ends of the deck are bent to turn upward to create a wheel guard 12 that significantly separates and protects the operator from the wheels 20 that are attached to each wheel guard 12 on the opposite side from the operator. The wheel assemblies 20 are attached to the wheel guard 12 by a plurality of metal axle studs 40 with the placement of each of the axle studs 40 onto the wheel guard 12 to establish the clearance between the bottom surface of the deck and the ground surface in the vertical direction. Further, the dimension is to provide for sufficient clearance for rough and uneven soil terrains typically found below houses and to provide adequate separation in the front to back direction between the plurality of wheels 20 that are grouped on the same side of each of the wheel guards 12. The wheel guards 12 shall be sufficiently rigid so as to resist pressure from the operator and provide adequate strength to support the attached wheel assemblies 20 and be shaped to be smaller in profile than the adjacent wheel tread 24. A hole 13 may be placed in each of the wheel guards 12 and through the deck assembly 10 in the front and back position to serve as handles and/or points of attachment for securing materials in place. The deck 11 width in the side to side direction and between the two turned up wheel guards 12 is to be sized to accommodate an operator while lying in the prone position. The deck 11 in the forward and back direction is to be shaped to accommodate an operator's body that may extend beyond the termination of the deck 11 material. Further, the deck 11 will preferably terminate so the wheel assemblies 20 extend beyond the deck 11 material in the forward and back direction yet sufficiently sized to provide support to the operator. A plane surface by means of laminating wood, plastic, metal and/or other composite assemblies, materials and methods that could be shaped to have integrated wheel guards 12 or attached wheel guards 12 as protection of the operator from the wheels 20. Further, the deck 11 could be made using a fabric, plastic or other suitable material to create a plane surface supported by a frame made of wood, metal, tubular metal, fiberglass or other composite materials suitable to create a frame formed into a closed shape. The wheel guards 12 could be integrated into the deck 11 shape by forming the deck 11 with a curvature in the up and down direction or by attaching a separate ridged material to each of the wheel assemblies by securing them directly to the frame or to the attached wheel assembly axle brackets.

The wheels 20 are of a size to fit into a low clearance area while maintaining low resistance while rolling across rough and soft surfaces such as soils. The wheel tread 24 are conducive for providing traction across rough terrain and soft soils. The wheel construction is sufficiently flexible to provide shock absorption. Wheels 20 are attached to the deck assembly 10 by a plurality of axle studs 40 protruding from the side of each of the deck assembly's wheel guards 12. Each wheel 20 will be supported by an axle stud 40 and secured in position in a manner that will allow the wheel 20 to rotate about the axle stud 40 while simultaneously preventing linear displacement along the length of the axle stud 40. The plurality of wheels 20 are sized to be larger in diameter than the clearance between the bottom of the deck assembly 10 and the ground surface for the purpose of remaining functional across the soft and rough terrain. Further, the size of the wheels 20 will preferably be larger in size than the dimension provided for clearance between the deck assembly 10 and ground surface. The wheels 20 will be a width sufficient to prevent excessive depression into soft soil surfaces. Further, the surface of the outer wheel 24, that contacts the ground materials, will be sufficiently textured to grip soil, concrete, metal or other materials that the wheels 20 may encounter during operation in locations including below a building. A plurality of wheels 20 similar to those used for skateboards, and smaller in diameter than the clearance between the bottom of the deck assembly 10 and ground surface may be placed below the deck assembly 10 in a linear pattern along each of the two sides in the front to back direction. The wheels may also be constructed in a manner to operate in conjunction with a rack or belt to assist in providing traction over soft ground surfaces.

A material is placed on top of the deck surface 11 and is water and tear resistant while being sufficiently soft to provide shock absorbing characteristics while shaped in a profile for the comfort of the operator. The padding 30 is constructed of a resilient foam that is tolerant of getting wet and resistant to abrasion. Padding 30 is attached to the deck assembly 10 surface for the purpose of providing comfort for the operator and include a center and two side sections that runs in the front to back direction of the deck assembly 10. The center section of the padding 30 is significantly smaller dimensional depth than the adjoining side padding 30 for the purpose of providing increased physical space in the center area of the deck surface 11 to accommodate a male operator's anatomy. The center section padding 30 may be omitted and the padding 30 may include only the two side padding 30 sections comprised of two individual sections. Further, each of the side padding 30 sections is approximately one-third the total deck width and each placed adjacent to each of the wheel guards 12. An alternate option is to utilize no padding, thus resulting in the deck surface 11 remaining exposed which is conducive for placement of materials in utilizing the deck surface 11 for supporting materials rather than an operator's body.

The axle studs 40 are preferably elongated and straight structures that have the purpose of receiving and securing a wheel assembly 20. The axle studs 40 have an attachment end 42 and an axle end 41. The shape of the axle stud 40 is cylindrical and is preferably larger in diameter at the attachment end 42 than the axle end 41 and creates a shoulder 43 to support one of the two sides of the wheel assembly 20. Further, the length of the widened attachment end 42 is a length sufficient to provide adequate clearance between the wheel assembly 20 and the wheel guard 12 that it is attached to. The axle stud 40 is smaller in diameter at the axle end 41 and is continuously straight for a length to be equal to the width of the wheel assembly hub 23 plus the thickness of the attachment washers 21 and threaded nut 22 necessary to secure the wheel assembly 20 to the axle stud 40. Threads 41 are cut into the end most area of the axle stud 40 for a length sufficient to receive the corresponding washers 21 and threaded nut 22 that secures the wheel assembly hub 23. The axle stud 40 may also be configured to be a continuous cylindrical straight structure attached to the wheel guard 12 and a larger diameter cylindrical sleeve, comprising a separate component, where the sleeve surrounds the axle stud 40 and placed at the attachment end 42 of the axle stud 40. An alternative variation could consist of the axle stud 40 with a threaded hole placed in the attachment end 42 that would receive a matching bolt as a means to secure it to a corresponding hole placed through the wheel guard 12. Another alternative method could be utilizing a bolt threaded along its shaft length as the axle component in combination with an interior threaded sleeve for the purpose of securing the axle stud assembly 40 to the wheel guard 12 and provide the necessary clearance between the wheel guard 12 and wheel assembly 20.

The axle stud 40 connects to the wheel guard 12 portion of the deck assembly 10 by a heat process whereby the two metal components are fused together. The wheel assembly 20 connects to the axle stud 40 by means of inserting the axle stud 40 through the hole placed in the wheel hub 23 to the point of contact with the shoulder 43 surface of the attachment end of the axle stud 42. Further a washer 21 is positioned between the shoulders 43 of the attachment end 42 of the axle stud 40 and surface of the wheel assembly hub 23 and a washer 21 is positioned between the surface of the wheel assembly hub 23 and a threaded nut 22 sufficiently tightened to secure the wheel assembly 20 to the axle stud 40. The padding 30 is secured to the deck surface 11 by means of attaching a plurality of hook 31 and loop 32 fasteners to the top surface of the deck assembly 10 and to the bottom surface of the padding 30. Further, the placement of the hook 31 fasteners attached to the padding 30 will be sufficiently positioned so as to align with the loop 32 fastener secured to the top side of the deck surface 11 such that the hook 31 and loop 32 fasteners are mated when the padding 30 is placed into position onto the deck surface 11. A pin inserted through a hole in the shaft of the axle stud 40 and perpendicular to its longest direction for the purpose of retaining the wheel assembly 20. Another alternate means of retaining the wheel assembly 20 would be to provide a threaded hole into the end of the axle stud 41 shaft to receive a threaded bolt with a head of sufficient size to retain the hub assembly 23. The padding 30 may be secured to the deck surface 11 using an adhesive or mechanical devices such as snaps or threaded screws. Further the padding 30 may be formed with shapes that could interlock with mated openings in the deck assembly 10 by means of applying pressure.

The invention functions to assist in the movement of an operator through small low clearance space with rough terrain ground surfaces such as the crawl space beneath a building. The operator generally lays down in a prone position and places the invention beneath their body and produces forward and backward movement by use of their arms and legs. Changing directional movement is accomplished by the operator applying pressure to the deck assembly wheel guard 12 in the direction that the operator desires to travel. Alternative operations may include the transportation of materials and may be but not required to be facilitated by removal of the padding 30. Further, a tether or other rope like device may be attached to the invention to achieve movement from a remote location.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described and accordingly, all suitable modifications and equivalents may be resorted to, falling within the scope of the invention.

We claim:

1. A confined space low profile rough terrain creeper comprising: a body platform suitably adapted to support a portion of a human being's body lying thereon, a plurality of axle studs, said axle studs being secured to said body platform, a plurality of wheels, said wheels to be rotatably connected to said axle studs and suitably sized to maintain low resistance over rough and soft surfaces whereby a person can traverse through a confined space with rough uneven terrain over under and around obstacles such as ventilation ducts and plumbing pipes and other commonly found obstructions in a crawlspace beneath a house.

2. A rough terrain creeper of claim 1 wherein said body platform of material of appropriate size to support a portion of a human being's body to allow the individual to extend forward and aft of said platform.

3. A rough terrain creeper of claim 1 wherein said body platform to be shaped to enable the user to mount and dismount while in a confined space environment.

4. A rough terrain creeper of claim 1 wherein said body platform to be shaped to provide directional control.

5. A rough terrain creeper of claim 1 wherein said axle studs are shaped and positioned as to provide adequate space between said body platform and said wheels.

6. A rough terrain creeper of claim 1 wherein said wheels are rotatably attached to said axle studs.

7. A rough terrain creeper of claim 1 wherein said wheels project below bottom plane surface of said platform a distance as to provide suitable clearance over uneven rough terrain.
